(19) United States
(12) Patent Application Publication
(10) Pub. No.: US 2011/0035582 A1
(43) Pub. Date: Feb. 10, 2011

(54) NETWORK AUTHENTICATION SERVICE SYSTEM AND METHOD

(75) Inventor: Hongwei ZHENG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/885,216

(22) Filed: Sep. 17, 2010

Related U.S. Application Data
(63) Continuation of application No. PCT/CN2009/070753, filed on Mar. 12, 2009.

(30) Foreign Application Priority Data
Mar. 17, 2008 (CN) 200810102058.1

(51) Int. Cl. H04L 29/06

(52) U.S. Cl. 713/152

(57) ABSTRACT

A network authentication service system and method are provided. The network authentication service system is applied to a network application layer and includes: a Web service security device, adapted to intercept a message exchanged in the network application layer; and an authentication server, adapted to perform authentication processing for the message intercepted by the Web service security device. The network authentication service method includes: intercepting a request message of a network application layer; performing encryption processing for the request message to obtain an encrypted message; performing authentication processing for the encrypted message; and decrypting the encrypted message that passes the authentication. Thus security processing can be performed for the transmitted message, and various security authentication manners can be available.

### CROSS-REFERENCE TO RELATED APPLICATIONS

This application is a continuation of International Application No. PCT/CN2009/070753 filed on Mar. 12, 2009, which claims priority to Chinese Patent Application No. 200810102058.1 filed on Mar. 17, 2008, both of which are hereby incorporated by reference in their entireties.

### FIELD OF THE INVENTION

The present invention relates to the field of network communication, and in particular to a network authentication service system and method.

### BACKGROUND OF THE INVENTION

With the continuous development of network (Web) services from a technical concept into practical use, Web services may be a very useful tool for future application infrastructure. The Web service features independence from language and platform. Therefore, when linking an application across enterprises or across the internet, the Web service has more and more apparent advantages. The Web service uses the Extensible Markup Language (XML) to exchange data. In the default condition, the XML is coded by plain text. In addition, most of the Web services use the Hypertext Transfer Protocol (HTTP), which also transmits data by way of plain text, as the transmission protocol. This causes unencrypted information to be transmitted through an unencrypted transmission protocol, thus threatening the secrecy of the information being transmitted.

Basic security requirements of enterprises with respect to Web services are as follows. First, data being transmitted over the internet should not be seen by a third party. Second, the receiving party and the transmitting party should both be able to determine the source of the data. Third, the receiving party and the transmitting party should both be able to determine that the data has not been tampered with during transmission. However, plain text XML and HTML cannot meet these basic security requirements of the enterprises. Therefore, the enterprises use various methods such as the Secure Socket Layer (SSL) protocol to prevent data from being seen by a third party, and the enterprises use digital signature and digital certificate technologies to determine the source of the data and determine that the data has not been tampered with.

As discussed above, various enterprises have differing security requirements. Some of the conventional techniques employed by enterprises nowadays are listed below. They are listed according to security level from low to high.

1. Authentication mechanisms, which are used to achieve security, such as the default access mechanism used in the J2EE Web service, and a filter used to control access in the Servlet technique.

2. Encrypted data transmission protocols, which are used to achieve security, such as SSL, HTTPS, etc.

### SUMMARY OF THE INVENTION

The embodiments of the present invention provide a network authentication service system and method, so as to meet the Web service security requirements of various enterprises.

An embodiment of the present invention provides a network authentication service system, which corresponds to a network application layer and includes: a Web service security device, adapted to intercept a message exchanged in the network application layer; and an authentication server, adapted to perform authentication processing for the message intercepted by the Web service security device.

Another embodiment of the present invention provides a network authentication service method which includes: intercepting a request message of a network application layer; performing encryption processing for the request message to obtain an encrypted message; performing authentication processing for the encrypted message; and decrypting the encrypted message if it passes the authentication.

By intercepting the message exchanged in the network application layer and performing security related processing for the intercepted message, the embodiments of the present invention can implement secure transmission for the message.

### BRIEF DESCRIPTION OF THE DRAWINGS

FIG. 1 is a diagram illustrating a structure of a network authentication service system according to a first embodiment of the present invention.

FIG. 2 is a diagram illustrating a network protocol relationship corresponding to the network authentication service system according to the first embodiment of the present invention.

FIG. 3 is a diagram illustrating the structure of the network authentication service system according to a second embodiment of the present invention.

FIG. 4 is a diagram illustrating a network relationship of Handlers of the network authentication service system according to an embodiment of the present invention.

FIG. 5 is a flowchart illustrating a network authentication service method according to an embodiment of the present invention.

FIG. 6 is a diagram illustrating a procedure of the network authentication service method according to another embodiment of the present invention.

FIG. 7 is a diagram illustrating an authentication procedure of the network authentication service method according to an embodiment of the present invention.

### DETAILED DESCRIPTION OF THE EMBODIMENTS

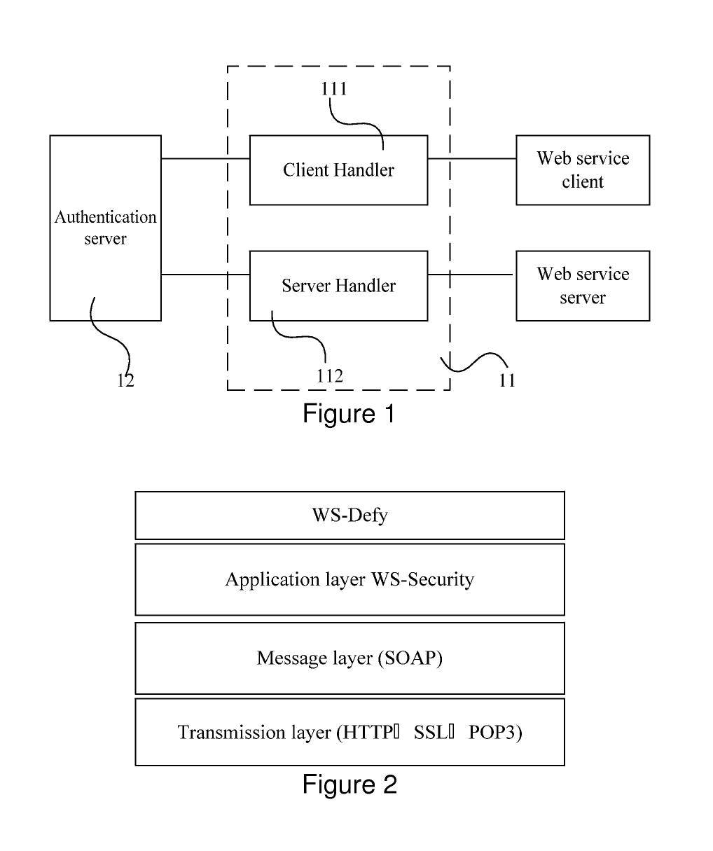

Referring to FIG. 1, a first embodiment of the present invention includes a network service security device 11 and an authentication server 12. The Web service security device 11 is adapted to intercept a message exchanged in the network application layer, and the authentication server 12 is adapted to perform authentication processing for the intercepted message. FIG. 2 illustrates a network protocol relationship corresponding to the network authentication service system according to the first embodiment of the present invention.

In this first embodiment, the network service security device 11 is specifically a Web service security device, of which the corresponding protocol WS-Defy is an extension of the existing Web service security standard, Web Services Security (hereinafter “WS-Security”). The WS-Security corresponds to the application layer of the Open System Interconnection Reference Model (OSI), and is established over the Simple Object Access Protocol (SOAP) standard. The WS-Security uses Extensible Markup Language (XML) to create a digital signature which uniquely corresponds to a particular party so as to authenticate whether the data is sent from the particular party, thus ensuring the integrity and intactness of the message during transmission. In addition, using XML encryption can encrypt part of the SOAP message, so as to provide security for the message.

To give an example, for a message exchanged between the Web service client and the Web service server of the application layer (e.g. the Web service client sends a request message used for calling a function to the Web service server, and the Web service server returns a corresponding response message to the Web service client), the system is configured between the Web service client and the Web service server to intercept the message and to perform authentication processing for the message (e.g. to intercept the request message sent from the Web service client to the Web service server and to perform authentication processing for the request message, and to intercept the response message sent from the Web service server to the Web service client and to perform authentication processing for the response message).

Specifically, the Web service security device 11 may include a client Handler 111 and a server Handler 112. The client Handler 111 is adapted to intercept messages sent from and received by the Web service client, and the server Handler 112 is adapted to intercept messages received by and sent from the Web service server. The authentication server 12 performs authentication processing for messages intercepted by the client Handler 111 and the server Handler 112. There are multiple phases before the Web service sends and receives the SOAP message, and a Handler may be registered at every phase, so as to perform pre-processing and post-processing for the SOAP message. When sending the SOAP message, using an OutHandler, the Web service performs post-processing such as encryption, signing, user identity information addition for the SOAP message. When receiving the SOAP message, using an InHandler, the Web service performs pre-processing such as decryption, signature authentication, user identity authentication for the SOAP message. Before being sent, the request and response SOAP message can be processed by a registered OutHandler to convert the SOAP message into the protected format of WS-Security. Before receiving the SOAP message, using an InHandler, the Web service server or the Web service client can convert the SOAP message in the protected format of WS-Security into a normal SOAP message for processing. Such operations are completely independent from the service processing logic, and the implementation of the WS-Defy is transparent for the service operation of the Web service.

By intercepting the message sent from or received by the Web service and performing security authentication and certification for the intercepted message, the embodiment implements a variety of security authentication. In addition, an authentication server used to perform authentication can be incorporated into the Single Sign On (SSO) authentication solution of the enterprise, where the authentication server is set at an SSO server, so as to implement centralized security authentication. Moreover, because the embodiment uses XML encryption, which corresponds to the application layer, the encryption can be performed only for the SOAP message header, and there is no need to encrypt the whole SOAP message. Thus encryption for part of the data can be realized and secure transmission can be implemented without dependency on the transmission layer.

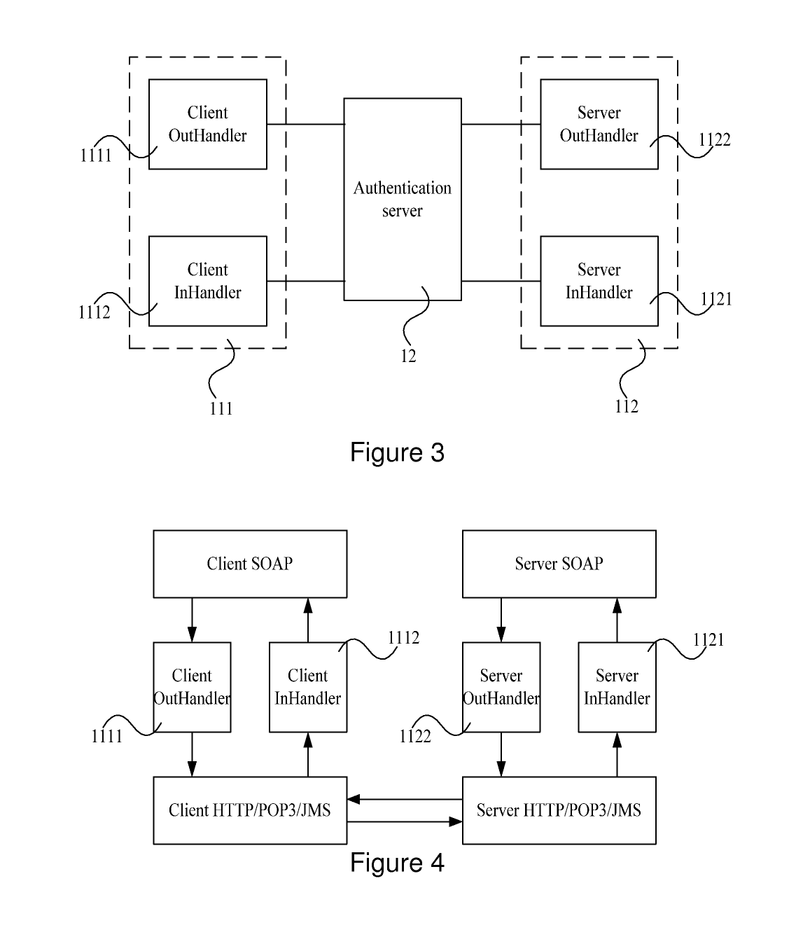

FIG. 3 illustrates the structure of the network authentication service system according to a further embodiment of the present invention. FIG. 4 illustrates a network relationship. In this embodiment, the client Handler 111 of this embodiment includes a client OutHandler 1111 and a client InHandler 1112, and the server Handler 112 includes a server InHandler 1121 and a server OutHandler 1122. The client OutHandler 1111 is adapted to intercept a request message sent from the Web service client to obtain a first authentication code from the authentication server 12 and to perform encryption processing for the request message according to the first authentication code to obtain an encrypted message. The server InHandler 1121 is adapted to intercept the encrypted message received by the Web service server and to send a server authentication message used for authenticating the encrypted message to the authentication server 12. The authentication server 12 authenticates the encrypted message intercepted according to the server authentication message. The server OutHandler 1122 is adapted to intercept a response message sent from the Web service server, to obtain a second authentication code from the authentication server 12, and to encapsulate the response message using the second authentication code to obtain an authentication message. The client InHandler 1112 is adapted to authenticate the authentication message received by the Web service client and to send a client authentication message used for authenticating the authentication message to the authentication server 12. The authentication server 12 authenticates the intercepted authentication message according to the client authentication message.

In this embodiment, the client and the server use different units to intercept and process the received and sent message respectively. Because the received and sent messages are processed separately, the device can be used more flexibly.

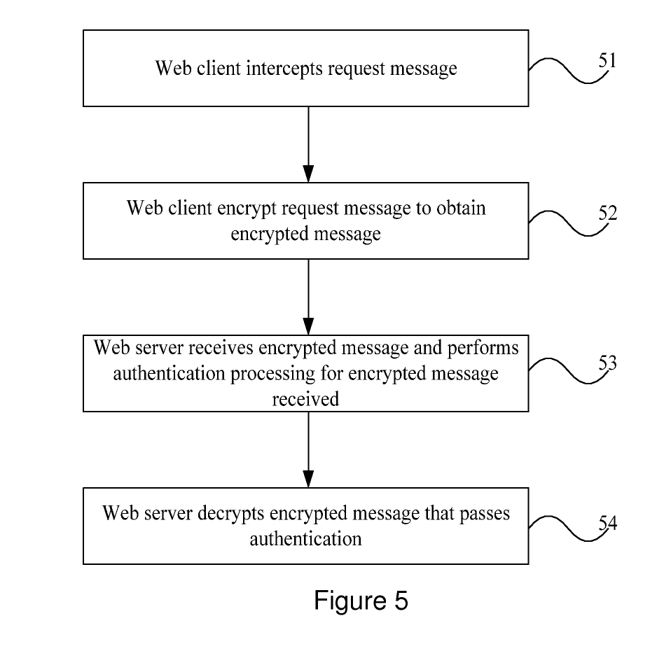

FIG. 5 is a flowchart illustrating a network authentication service method according to a yet another further embodiment of the present invention. The method includes: intercepting a message exchanged in the application layer and performing authentication processing for the intercepted message. Referring to FIG. 5, the specific processes for steps 51-54 are as follows.

Step 51: The Web service security device (e.g. the client OutHandler) intercepts a request message sent from the Web service client.

Step 52: The Web service security device (e.g. the client OutHandler) performs encryption processing for the request message (e.g. requests an authentication code from the authentication server and matches the authentication code to the request message) to obtain an encrypted message, and sends the encrypted message to the Web service server.

Step 53: The Web service security device (e.g. the server InHandler) receives the encrypted message (Practically, the encrypted message can be sent to the Web server directly. However, to authenticate an encrypted message, a call-back function can be added into the encrypted message to call the encrypted message back to the server InHandler, so as to perform further authentication), and performs authentication processing for the encrypted message using the authentication server.

Step 54: The Web service security device (e.g. the server InHandler) decrypts the encrypted message that passes the authentication.

This embodiment can intercept the message exchanged between the Web service client and the Web service server and further perform security related processing such as authentication for the intercepted message, so as to implement secure transmission for the message.

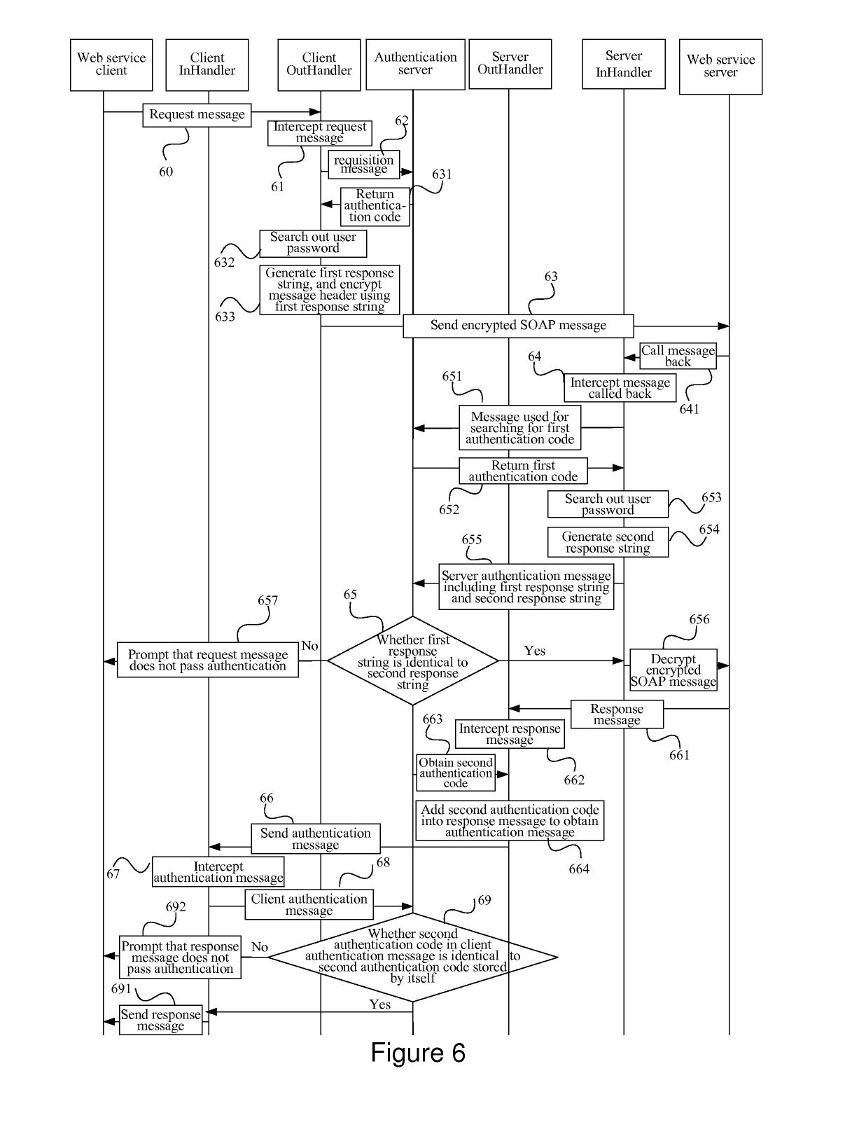

FIG. 6 is a diagram illustrating a procedure of the network authentication service method according to yet another further embodiment of the present invention. The method includes the following steps 60-69.

Step 60: The Web service client sends a SOAP request message.

Step 61: The client OutHandler intercepts the received SOAP request message.

Specifically, according to the provision of WS-Security, the request message includes a message body and a message header. The message header includes information such as a user name configured by the client. Interception for the Web service client can be implemented by way of configuration, e.g. by registering the OutHandler service in the Web service, where when the Web service client sends the SOAP request message to the Web service server, the client OutHandler may intercept the request message according to the configuration file. The OutHandler service performs pre-processing for the SOAP request message sent from the client, adds WS-Security information, and imports necessary configuration information and a class file. Therefore, by converting the Document Object Model (DOM) into a stream model of STAX (Streaming API for XML) using the DOMOutHandler, and by additionally defining a WSS4JOutHandler to implement the operation of adding authentication information into the SOAP header, the client OutHandler can connect the authentication server to request and to response to the authentication information.

Step 62: After intercepting the request message, the client OutHandler sends a requisition message used for obtaining a first authentication code to the authentication server.

Step 63: The client OutHandler encrypts and encapsulates the intercepted request message using the first authentication code which is obtained according to the requisition message, and sends the same.

Specifically, the encrypted message can be formed through the following steps. The client OutHandler obtains the first authentication code from the authentication server and generates a random number by itself (Step 631); searches out a user password according to a user name carried in the request message (Step 632); and generates a first response string according to the authentication code, the random number, the user name, the user password, and the message body of the request message, and encrypts and encapsulates the request message using the first response string and the user name (Step 633). Corresponding steps for encrypting the intercepted message may be as follows.

The first step: The authentication server sends the first authentication code to the client OutHandler according to the requisition request sent from the client OutHandler, where the first authentication code includes a random number “nonce” and a random string “realm.”

The second step: The client OutHandler generates a random number “cnonce” by itself, and searches out the user password according to the user name.

The third step: Generate the first response string (response 1) according to an algorithm arranged between the Web service server and the Web service client. Specifically, the steps for generating the first response string are as follows:
1. Perform md5 hashing for the user name+realm+user password, and perform hexadecimal coding (lowercase) for the hashed result, to generate a key1.
2. Perform md5 hashing for the message body of the request message, and perform hexadecimal character coding for the hashed result, to generate a key2.
3. Perform md5 hashing for the key1+“:”+nonce+“:”+cnonce+“:”+key2, and perform hexadecimal character coding for the hashed result, to generate the final first response string.

The fourth step: Re-encapsulate the SOAP request message using the generated first response string, where the header of the encapsulated SOAP message includes at least the first response string and the user name.

The fifth step: Send the encapsulated SOAP message to the Web service server.

Step 64: The server InHandler intercepts the encrypted message sent from the client OutHandler to the Web service server (Because practically the encrypted message is usually sent to the Web service server, the encrypted message may be called back to the server InHandler so as to be authenticated. Alternatively, by configuration, the encrypted message may be sent to the server InHandler directly, where there is no reason to call back). Before this, the server InHandler calls back the encrypted request message from the Web service server (Step 641). Similar to the OutHandler configured at the Web service client, because the Web service server may intercept, the Web service server may be configured with the InHandler, which may be performed as follows: the Web service server creates an applicationContext-ws-security.xml file, to make the Web service possess authentication and interception functions. The configuration file is mainly adapted to configure the name of the Web service, to be responsible for converting the SOAP which is of the STAX stream model into the DOM model, to configure the authentication and certification manner, to import the necessary class, and to call back the implementation class to call the encrypted request message back from the Web server to the server InHandler. The InHandler can connect the authentication server to request and to response to the authentication information.

Step 65: The authentication server authenticates the encrypted message according to a server authentication message sent from the server InHandler. Specifically, the server authentication message may be formed as follows.

Step 651: The server InHandler searches for and obtains the above first authentication code from the authentication server according to the user name carried in the encrypted message called back, where the first authentication code includes the “nonce” and the “realm.”

Step 652: The authentication server sends the first authentication code to the server InHandler, revokes the previous first authentication code “nonce,” and generates and stores a new second authentication code “nextnonce.”

Step 653: The server InHandler searches out the user password according to the user name.

Step 654: The server InHandler generates a second response string (response 2) according to the above first authentication code (the “nonce” and the “realm”), the user name, the user password, and the message body of the encrypted message called back.

The idea of the method for generating the second response string is the same as that of the first response string, except that it is the message body of the request message that is hashed when generating the first response string, while it is the message body of the encrypted message called back that is hashed when generating the second response string.

Step 655: The server InHandler adds the first response string carried in the encrypted message called back and the second response string generated as described above into the server authentication message, and sends the same to the authentication server.

Specifically, the authentication process of the authentication server is as follows. The authentication server determines whether the encrypted message passes authentication by comparing the first response string with the second response string to determine whether they are identical. If the first response string is identical to the second response string, it is determined that it passes the authentication. Otherwise, it is determined that it does not pass the authentication. Step 656 is executed for an encrypted message that passes the authentication, and Step 657 is executed for an encrypted message that does not pass the authentication.

Step 656: The authentication server sends a message that passes the authentication to the server InHandler, and instructs the server InHandler to decrypt the encrypted message that passes the authentication.

Step 657: The authentication server sends a prompt such as an indication that the request does not pass the authentication to the Web service client, and ends the procedure.

The above procedure allows the Web service server to authenticate and certificate the SOAP request message sent from the Web service client. Then the Web service server may send a response message to the Web service client. In yet another further embodiment, the Web service client may also implement authentication for the response message, which may include the following steps.

Step 66: The Web service server sends an authentication message, which is obtained by adding authentication to the response message corresponding to the request message. Specifically, the authentication message is obtained as follows.

Step 661: The Web service server returns the response message corresponding to the above request message.

Step 662: The server OutHandler intercepts the response message.

Step 663: The server OutHandler obtains a second authentication code “nextnonce” from the authentication server.

Step 664: The server OutHandler adds the second authentication code into the message header of the response message to obtain the authentication message.

Step 67: The client InHandler intercepts the authentication message. Specifically, the authentication message can be configured to be sent to the client InHandler directly. Alternatively, it can be sent firstly to the Web service client, and then be called back from the Web service client to the client InHandler.

Step 68: The client InHandler sends a client authentication message to the authentication server. Specifically, the client authentication message contains the second authentication code “nextnonce” carried in the authentication message. If the authentication message is not modified, the authentication code “nextnonce” is identical to that stored in the authentication server. If the authentication message is changed, the authentication code carried in the authentication message is also changed.

Step 69: The authentication server determines whether the response message of the request message passes the authentication by performing comparison to determine whether the second authentication code in the client authentication message is identical to the second authentication code “nextnonce” stored by itself. If the second authentication code sent from the client InHandler is identical to the second authentication code stored in the authentication server, it is determined that the authentication message is not tampered with, i.e. the response message sent from the Web service server passes the authentication, and execute Step 691. Otherwise, it is determined that it does not pass the authentication, and execute Step 692.

Step 691: The authentication server instructs the client InHandler to send the decrypted authentication message, i.e. send the response message of the request message, to the Web service client.

Step 692: The authentication server sends a prompt, such as an indication that the response does not pass the authentication to the Web service client.

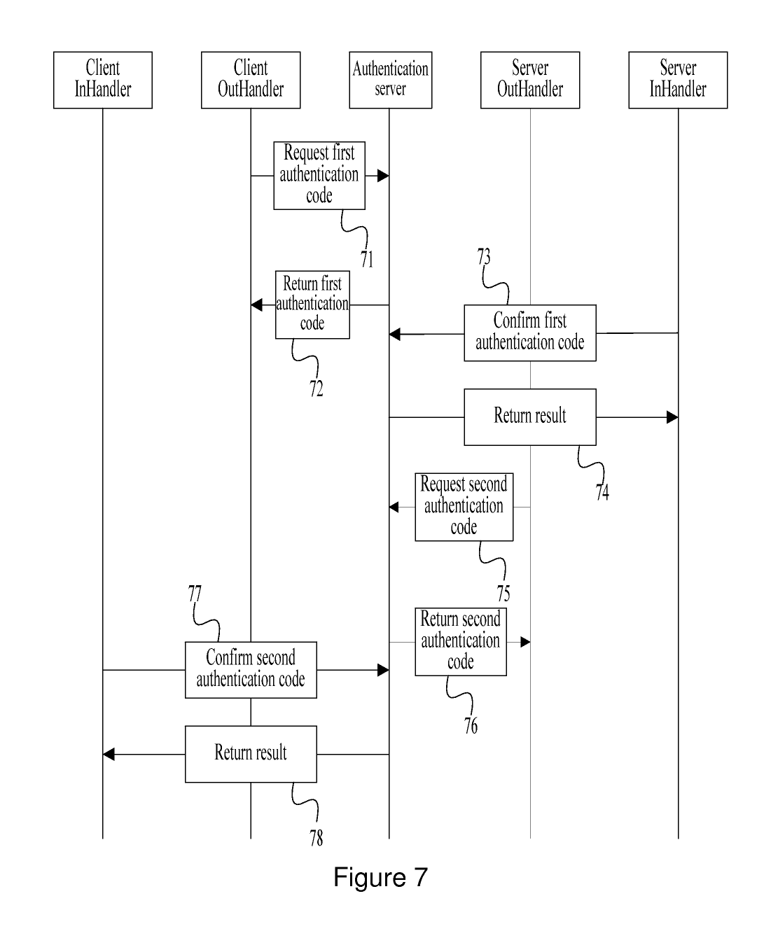

The above procedure shows the whole SOAP message transmission process where the SOAP message is sent from the Web service client to the Web service server, the Web service server authenticates, the Web service server returns the response message, and the Web service client authenticates. The authentication procedure with respect to the authentication server is illustrated in FIG. 7, which illustrates an authentication procedure of the network authentication service method according to one embodiment of the present invention. The authentication procedure includes the following steps.

Step 71: The client OutHandler requests the first authentication code from the authentication server.

Step 72: The client OutHandler receives the first authentication code, and matches the first authentication code to the request message to implement encryption for the request message.

Step 73: The server InHandler receives the encrypted message, and sends a request used for confirming the first authentication code, i.e. used for authenticating whether the encrypted message received is tampered with, to the authentication server.

Step 74: The authentication server authenticates the encrypted message according to information sent from the server InHandler, and returns a corresponding result.

Step 75: The server OutHandler requests the second authentication code from the authentication server, and obtains the authentication message.

Specifically, if the encrypted message is valid (passing the authentication), the server returns a response message to the client, which is similar to the client sends the request message. The server adds authentication to the response message sent, so as to make the client be able to authenticate whether the received message is tampered with. Thus, when returning the response message, the server can add the second authentication code to the response message to obtain the authentication message. After receiving the authentication message, the client may perform authentication, e.g. confirm the second authentication code.

Step 76: The authentication server returns the second authentication code, so as to make the server OutHandler add authentication to the response message.

Step 77: The client InHandler sends a request used for confirming the second authentication code to the authentication server.

Step 78: The authentication server returns a corresponding authentication result.

The authentication method of the embodiment utilizes the user name and the user password. Alternatively, a digital signature authentication, a fingerprint authentication, and the like, may be performed on the intercepted message. Moreover, in order to implement flexible authentication, the client Handler and the server Handler are respectively divided into two units of receiving and sending. Alternatively, the client and the server may respectively use one Handler, or the client and the server may use the same Handler, so as to implement message intercepting function.

In the embodiment, by extending the WS-Security standard, i.e. by intercepting the SOAP message, various security authentication manners can be implemented for the Web service. In the embodiment, using the authentication server to perform authentication can be incorporated into the Single Sign On (SSO) authentication solution of the enterprise, where the authentication server is set at the SSO server, so as to implement centralized security authentication. The embodiment does not use encrypted transmission layer protocols, e.g. the HTTPS protocol of the transmission layer, thus ensuring the independence of the Web service from the transmission layer. In addition, by using the XML of the WS-Security to exchange data, the encryption can be performed only for the SOAP message header, and there is no need to encrypt the whole SOAP message, thus saving performance overheads. The client and the server are configured with Handlers, using which special security processing such as log auditing and data packet compression can be performed for the service.

It should be noted that, those ordinarily skilled in the art can understand that all or part of the steps in the above embodiments of the method can be implemented by program instructing relevant hardware, and the program, which performs a step of the above embodiments of the method when executed, may be stored in a computer readable storage medium, such as a magnetic disk, an optical disk, a Read-Only Memory (ROM), or a Random Access Memory (RAM).

Finally, it should be noted that the above embodiments are merely provided for describing the technical solutions of the present invention, but not intended to limit the present invention. It should be understood by persons of ordinary skill in the art that although the present invention has been described in detail with reference to the embodiments, modifications can be made to the technical solutions described in the embodiments, or equivalent replacements can be made to some technical features in the technical solutions, as long as such modifications or replacements do not depart from the scope of the present invention.

1. A network authentication service method, comprising:
intercepting, by a client OutHandler, a request message of a network application layer;
performing, by the client OutHandler, encryption processing for the request message to obtain an encrypted message, and sending the encrypted message to a Web service server;
receiving, by a server InHandler, the encrypted message, and performing authentication processing for the encrypted message; and
decrypting, by the server InHandler, the encrypted message that passes the authentication.

2. The network authentication service method according to claim 1, wherein the performing encryption processing for the request message to obtain an encrypted message comprises:
sending a requisition message to an authentication server for obtaining a first authentication code;
obtaining the first authentication code from the authentication server, and generating a random number;
searching out a user password according to a user name carried in the request message; and
generating a first response string according to the first authentication code, the random number, the user name, the user password, and a message body of the request message, and encrypting and encapsulating the request message using the first response string and the user name to obtain the encrypted message.

3. The network authentication service method according to claim 2, wherein the performing authentication processing for the encrypted message comprises:
obtaining the first authentication code and the user password according to the user name carried in the encrypted message;
generating a second response string according to the first authentication code, the user name, the user password, and the message body of the received encrypted message, and
determining, by the authentication server, the received encrypted message as passing the authentication if the first response string is identical to the second response string.

4. The network authentication service method according to claim 1, further comprising:
intercepting, by a server OutHandler, a response message which corresponds to the encrypted message;
adding, by the server OutHandler, authentication to the response message to obtain an authentication message;
intercepting, by a client InHandler, the authentication message, and performing authentication processing for the authentication message; and
decrypting, by the client InHandler, the authentication message that passes the authentication.

5. The network authentication service method according to claim 4, wherein the adding authentication to the response message to obtain an authentication message comprises:
obtaining a second authentication code; and
encapsulating the response message using the second authentication code to obtain the authentication message.

6. The network authentication service method according to claim 5, wherein the performing authentication processing for the authentication message comprises:
determining, by the authentication server, the authentication message as passing the authentication if the second authentication code carried in the authentication message is identical to a stored second authentication code.

7. A network authentication service system, comprising:
a client OutHandler, configured to intercept a request message of a network application layer, perform encryption processing for the request message to obtain an encrypted message, and send the encrypted message to a Web service server; and
a server InHandler, configured to receive the encrypted message, perform authentication processing for the encrypted message, and decrypt the encrypted message that passes the authentication.

8. The network authentication service system according to claim 7, further comprising:
an authentication server, wherein the client OutHandler is further configured to send a requisition message to the authentication server for obtaining a first authentication code, obtain the first authentication code from the authentication server, generate a random number, search out a user password according to a user name carried in the request message, generate a first response string according to the first authentication code, the random number, the user name, the user password, and a message body of the request message, and encrypt and encapsulate the request message using the first response string and the user name to obtain the encrypted message.

9. The network authentication service system according to claim 8, wherein the server InHandler is further configured to obtain the first authentication code and the user password according to the user name carried in the encrypted message, generate a second response string according to the first authentication code, the user name, the user password, and the message body of the received encrypted message; and
the authentication server is further configured to determine the received encrypted message as passing the authentication if the first response string is identical to the second response string.

10. The network authentication service system according to claim 7, further comprising:
a server OutHandler, configured to intercept a response message which corresponds to the encrypted message and add authentication to the response message to obtain an authentication message; and
a client InHandler, configured to intercept the authentication message, perform authentication processing for the authentication message, and decrypt the authentication message that passes the authentication.

11. The network authentication service system according to claim 10, wherein the server OutHandler is further configured to obtain a second authentication code and encapsulate the response message using the second authentication code to obtain the authentication message.

12. The network authentication service system according to claim 11, wherein the authentication server is further configured to determine the authentication message as passing the authentication if the second authentication code carried in the authentication message is identical to a stored second authentication code.
